(19) United States
(12) Patent Application Publication
(10) Pub. No.: US 2023/0064912 A1
(43) Pub. Date: Mar. 2, 2023

(54) REPETITION INFORMATION IN TRANSMISSION BURST

(71) Applicants: Jing LEI, San Diego, CA (US); Chao WEI, San Diego, CA (US); Wanshi CHEN, San Diego, CA (US); Huilin XU, San Diego, CA (US); Peter Pui Lok ANG, San Diego, CA (US); Peter GAAL, San Diego, CA (US); Hwan Joon KWON, San Diego, CA (US); Krishna Kiran MUKKAVILLI, San Diego, CA (US); Tingfang JI, San Diego, CA (US); QUALCOMM Incorporated, San Diego, CA (US)

(72) Inventors: Jing LEI, San Diego (US); Chao WEI, Beijing (CN); Wanshi CHEN, San Diego (US); Huilin XU, Temecula (US); Peter Pui Lok ANG, San Diego (US); Peter GAAL, San Diego (US); Hwan Joon KWON, San Diego (US); Krishna Kiran MUKKAVILLI, San Diego (US); Tingfang JI, San Diego (US)

(21) Appl. No.: 17/797,061

(22) PCT Filed: Apr. 3, 2020
(86) PCT No.: PCT/CN2020/083240

§ 371 Date: Aug. 2, 2022

(51) Int. Cl. H04L 1/08; H04W 72/04

(52) U.S. Cl. CPC H04L 1/08; H04W 72/0466

(57) ABSTRACT

Aspects of the present disclosure include methods, apparatuses, and computer readable media for generating a first scrambling identification (ID), generating a first scrambling sequence based on the first scrambling ID, scrambling a first set of information based on the first scrambling sequence to generate a first plurality of information bits, generating a plurality of repeated copies of the first plurality of information bits scrambled using the first scrambling sequence, and transmitting a first transmission burst including each of the plurality of repeated copies of the first plurality of information bits on different ones of a first plurality of resources in a communication channel.

### BACKGROUND

Aspects of the present disclosure relate generally to wireless communications, and more particularly, to apparatuses and methods for transmitting repetition of information in a transmission burst.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data; ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

In a wireless communication network, a base station (BS) may transmit redundant information to a user equipment (UE) to enable coverage enhancement. However, transmitting redundant information may place more computational load on the BS and/or UE due to the need for scrambling/descrambling, coding/decoding, etc. Further, the complexity of the BS and/or UE may need to be higher to transmit redundant information. Therefore, improvements in transmitting redundant information may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include methods for generating a first scrambling identification (ID), generating a first scrambling sequence based on the first scrambling ID, scrambling a first set of information based on the first scrambling sequence to generate a first plurality of information bits, generating a plurality of repeated copies of the first plurality of information bits scrambled using the first scrambling sequence, and transmitting a first transmission burst including each of the plurality of repeated copies of the first plurality of information bits on different ones of a first plurality of resources in a communication channel.

Other aspects of the present disclosure include a device having a memory comprising instructions, at least one transceiver, and at least one processor communicatively coupled to the memory and the at least one transceiver, the instructions executable by the at least one processor to cause the device to execute instructions in the memory to generate a first scrambling identification (ID), generate a first scrambling sequence based on the first scrambling ID, scramble a first set of information based on the first scrambling sequence to generate a first plurality of information bits, generate a plurality of repeated copies of the first plurality of information bits scrambled using the first scrambling sequence, and transmit a first transmission burst including each of the plurality of repeated copies of the first plurality of information bits on different ones of a first plurality of resources in a communication channel.

An aspect of the present disclosure includes a device including means for generating a first scrambling identification (ID), means for generating a first scrambling sequence based on the first scrambling ID, means for scrambling a first set of information based on the first scrambling sequence to generate a first plurality of information bits, means for generating a plurality of repeated copies of the first plurality of information bits scrambled using the first scrambling sequence, and means for transmitting a first transmission burst including each of the plurality of repeated copies of the first plurality of information bits on different ones of a first plurality of resources in a communication channel.

Some aspects of the present disclosure include non-transitory computer readable media having instructions stored therein that, when executed by one or more processors of a device, cause the device to generate a first scrambling identification (ID), generate a first scrambling sequence based on the first scrambling ID, scramble a first set of information based on the first scrambling sequence to generate a first plurality of information bits, generate a plurality of repeated copies of the first plurality of information bits scrambled using the first scrambling sequence, and transmit a first transmission burst including each of the plurality of repeated copies of the first plurality of information bits on different ones of a first plurality of resources in a communication channel.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram of an example of a wireless communications system and an access network;

FIG. 2 is a schematic diagram of an example of a user equipment;

FIG. 3 is a schematic diagram of an example of a base station;

FIG. 4 is a block diagram of an example of a codeword scrambling process;

FIG. 5 is a block diagram of an example of a reference signal scrambling process;

FIG. 6 is a block diagram of an example of a process of transmitting a transmission burst;

FIG. 7 is a graph of frequency over time including an example of resources used for transmitting transmission bursts;

FIG. 8 is a graph of frequency over time including an example of common phase rotation in resource elements of the same symbol that may be used for mitigating inter-cell interference when transmitting transmission bursts;

FIG. 9 is a block diagram of an example of a process of receiving a transmission burst;

FIG. 10 is a flow diagram of an example of a method for transmitting a transmission burst; and

FIG. 11 is a flow diagram of an example of a method for receiving a transmission burst

An appendix, the contents of which are incorporated in their entireties, is attached.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In an aspect of the present disclosure, repetition based transmission may be utilized to enhance coverage for physical channels and/or reference signals. Examples of such transmissions may include, but are not limited to, slot/mini-slot based repetition for data channels (e.g., physical downlink shared channel (PDSCH) or physical uplink shared channel (PUSCH)), repetition of physical control channels (e.g., physical broadcast channel (PBCH), or physical downlink control channel (PDCCH), or physical uplink control channel (PUCCH)), or bundling of reference signals across multiple slots/mini-slots. Repetition/bundling may be combined with frequency hopping and/or phase randomization. To reduce implementation complexity of the UE in combining and/or generating multiple replicas of the physical channels/signals, same scrambling sequences may be repeated across repetitions of control/data channels and bundles of reference signals. Also, in some implementations, in the presence of frequency hopping, redundancy version (RV) cycling, or pre-coder cycling, different scrambling sequences may be applied to indicate the change of transmission schemes. Additionally, in some implementations, to mitigate the inter-cell interference, OFDM symbol-level phase randomization may be used in conjunction with the above scrambling procedures.

In certain implementations, to achieve enhanced coverage during uplink (UL) or downlink (DL) transmission, prolonged transmission time may be utilized by the UE or the BS without reduced capabilities or increased complexity in hardware or software. Prolonged transmission may be contiguous or non-consecutive in time domain. For example, full-duplex frequency division duplex (FD-FDD) may be used to achieve consecutive or contiguous, or non-consecutive or non-contiguous, transmission of the prolonged transmission in UL and/or DL. Further, for example, half-duplex frequency division duplex (HD-FDD) or time division duplex (TDD) may be used to achieve non-consecutive transmission of the prolonged transmission in UL and/or DL. Prolonged transmission may be partitioned in the time domain into one or more transmission bursts, where a transmission burst includes two or more repetitions or repeated copies of the same information. A transmission burst may be indexed by N_{ID}^{burst}, which spans multiple slots or multiple mini-slots. The repetitions and/or bundling of physical signals and reference signals within a transmission burst may be consecutive or non-consecutive in time. Notably, as described in more detail herein, within a transmission burst, the transmission scheme of the codeword in frequency (or space) domain remains unchanged. For example, in one implementation, transmission scheme parameters such as the RV, precoding, or frequency mapping schemes for the repetitions within a transmission burst may be fixed. Further, for example, the transmission scheme (e.g., at least one of the transmission scheme parameters) may change from one transmission burst to another transmission burst.

In some implementations, a device (e.g., for wireless communication), also referred to as a transmitter/receiver/transceiver (such as a BS or a UE) may generate a scrambling sequence to be repeatedly applied to each repeated copy or repletion of information for a physical channel within a transmission burst. The scrambling sequence may be, for example, a binary pseudorandom noise sequence based on a scrambling identification (ID). The scrambling ID may include, but is not limited to, a random number, a cell-specific scrambling ID (for multicast or broadcast), or a UE-specific scrambling ID (for unicast). For example, the transmitter may utilize the scrambling sequence to scramble (e.g., perform an XOR operation) a codeword sequence into scrambled bits prior to transmission. In one example, the transmitter may transmit redundant copies of the scrambled bits to a receiver in a transmission burst. The redundant copies of the scrambled bits may be scrambled with the same scrambling sequence.

In alternative or additional implementations, the transmitter may generate a scrambling sequence for a reference signal within a transmission burst based on a reference scrambling ID, which may be the same or different from the scrambling ID discussed above. This scrambling sequence may be referred to as a reference scrambling sequence. The transmitter may map the reference scrambling sequence, for example, from a binary sequence to a quaternary sequence. The quaternary sequence may be multiplexed with one or more of the redundant copies of the scrambled bits. The quaternary sequence may be used as reference signals for UL and/or DL transmissions (e.g., demodulation reference signal (DMRS), channel state indicator reference signal (CSI-RS), phase tracking reference signal (PT-RS), sound reference signal (SRS), timing reference signal (TRS), etc.).

In certain aspects in either of the above implementations, the scrambling ID and/or the reference scrambling ID may be a 31-bit ID. The IDs may be time-variant, UE-specific, and/or cell-specific.

Thus, based on the foregoing, the present disclosure provides simplified scrambling procedures that may be used to efficiently enable coverage enhancement in wireless communication networks.

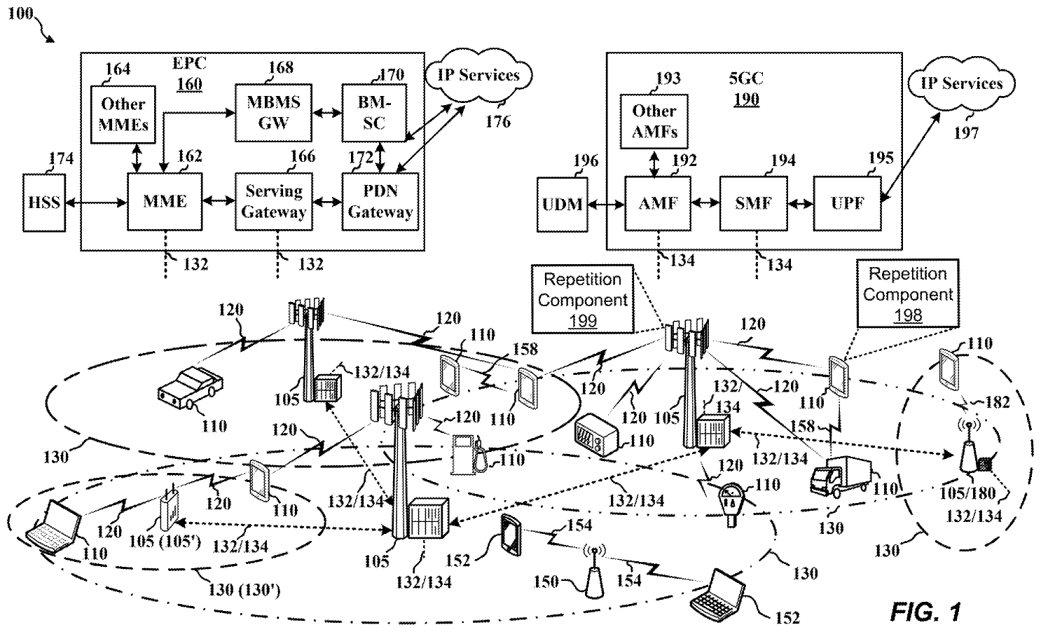

Referring to FIGS. 1-3, an example of a wireless communications network 100, which may be also referred to as a wireless wide area network (WWAN), includes at least one BS 105 having repetition component 199 and at least one UEs 110 having repetition component 198 each configured to perform simplified scrambling/descrambling procedures on repetition-based transmissions to enhance coverage within the wireless communications network 100. The BS 105 and/or UE 110 may communicate with one another and with one or both of an Evolved Packet Core (EPC) 160 or a 5G Core (5GC) 190. The BS 105 may include macro cells (high power cellular base station) and/or small cells (low power cellular base station). The macro cells include base stations. The small cells include femtocells, picocells, and microcells.

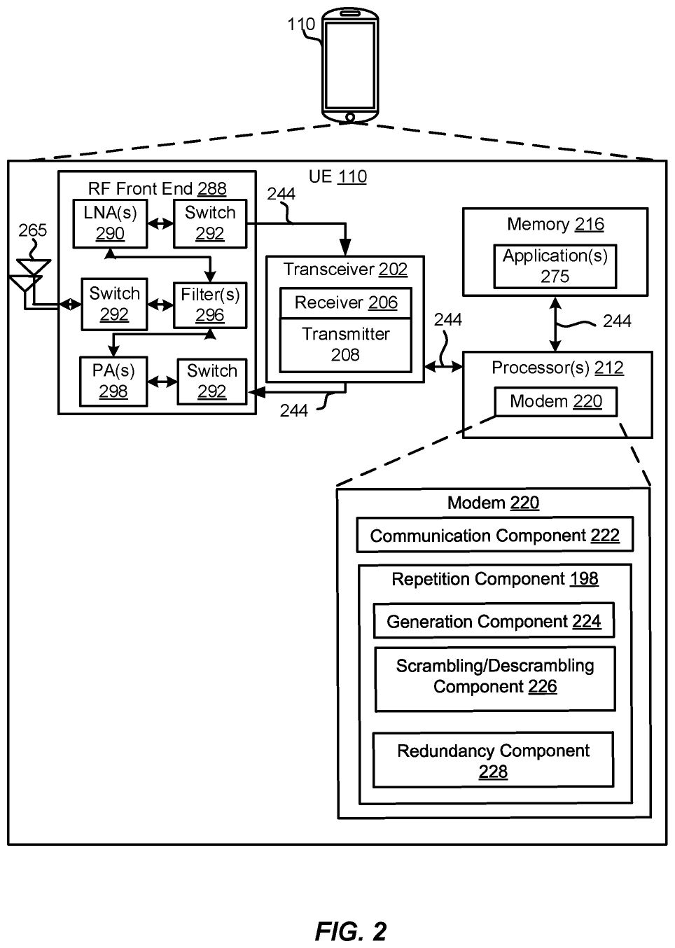

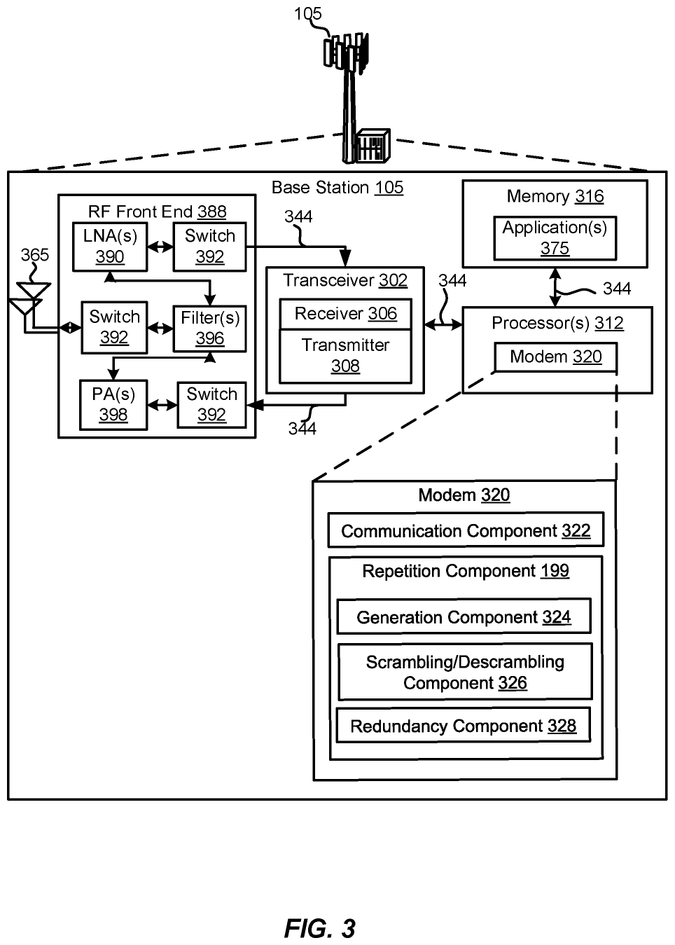

Referring more specifically to FIGS. 2-3, in one implementation, the UE 110 acting as a transmitter device may include a modem 320 having a communication component 222 that operates in cooperation with the repetition component 198 to communicate multiple repetitions of information having a same scrambling sequence to a receiver device, such as the BS 105. The communication component 222 and/or a modem 220 of the UE 110 may be configured to communicate with the BS 105 via a cellular network, a Wi-Fi network, or other wireless and wired networks. The repetition component 198 of the UE 110 may include a generation component 224 configured to generate scrambling IDs and/or scrambling sequences. The UE 110 may include a scrambling/descrambling component 226 configured to scramble a bit sequence using a scrambling sequence (e.g., using an XOR operator). The UE 110 may include a redundancy component 228 that duplicates scrambled bits prior to transmission such that, within a given transmission burst, the duplicated, repeated, or redundant information each have a same scrambling sequence to allow for more efficient descrambling at a receiver, such as at the scrambling/descrambling component 326 the BS 105.

Similarly, in some implementations, the BS 105 acting as the transmitter device may include a modem 320 having a communication component 322 that operates in cooperation with the repetition component 199 to communicate multiple repetitions of information having a same scrambling sequence to a receiver device, such as the UE 110. The repetition component 199 of the BS 105 may include a generation component 324 configured to generate scrambling IDs and/or scrambling sequences. The BS 105 may include a scrambling/descrambling component 326 configured to scramble a bit sequence using a scrambling sequence (e.g., using an XOR operator). The BS 105 may include a redundancy component 328 that duplicates scrambled bits prior to transmission such that, within a given transmission burst, the duplicated, repeated, or redundant information each have a same scrambling sequence to allow for more efficient descrambling at a receiver, such as at the scrambling/descrambling component 226 the UE 110.

Referring back to FIG. 1, a BS 105 configured for 4G LTE (collectively referred to as Evolved Universal Mobile Telecommunications System (UMTS) Terrestrial Radio Access Network (E-U IRAN)) may interface with the EPC 160 through backhaul links interfaces 132 (e.g., S1, X2, Internet Protocol (IP), or flex interfaces). A BS 105 configured for 5G NR (collectively referred to as Next Generation RAN (NG-RAN)) may interface with 5GC 190 through backhaul links interfaces 134 (e.g., S1, X2, Internet Protocol (IP), or flex interface). In addition to other functions, the BS 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The BS 105 may communicate directly or indirectly (e.g., through the EPC 160 or 5GC 190) with each other over the backhaul links interfaces 134. The backhaul links 132, 134 may be wired or wireless.

The BS 105 may wirelessly communicate with the UEs 110. Each of the BS 105 may provide communication coverage for a respective geographic coverage area 130. There may be overlapping geographic coverage areas 130. For example, the small cell 105′ may have a coverage area 130′ that overlaps the coverage area 130 of one or more macro BS 105. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the BS 105 and the UEs 110 may include uplink (UL) (also referred to as reverse link) transmissions from a UE 110 to a BS 105 and/or downlink (DL) (also referred to as forward link) transmissions from a BS 105 to a UE 110. The communication links 120 may use multiple-input and multiple-output (MIMO) antenna technology, including spatial multiplexing, beamforming, and/or transmit diversity. The communication links may be through one or more carriers. The BS 105/UEs 110 may use spectrum up to Y MHz (e.g., 5, 10, 15, 20, 100, 400, etc. MHz) bandwidth per carrier allocated in a carrier aggregation of up to a total of Yₓ MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 105′ may operate in a licensed and/or an unlicensed frequency spectrum. When operating in an unlicensed frequency spectrum, the small cell 105′ may employ NR and use the same 5 GHz unlicensed frequency spectrum as used by the Wi-Fi AP 150. The small cell 105′, employing NR in an unlicensed frequency spectrum, may boost coverage to and/or increase capacity of the access network.

A BS 105, whether a small cell 105′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 110. When the gNB 180 operates in mmW or near mmW frequencies, the gNB 180 may be referred to as an mmW base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 110 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 110 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the BS 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The BS 105 may also be referred to as a gNB, Node B, evolved Node B (eNB), an access point, a base transceiver station, a radio base station, an access point, an access node, a radio transceiver, a NodeB, eNodeB (eNB), gNB, Home NodeB, a Home eNodeB, a relay, a transceiver function, a basic service set (BSS), an extended service set (ESS), a transmit reception point (TRP), or some other suitable terminology. The BS 105 provides an access point to the EPC 160 or 5GC 190 for a UE 110. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.). The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring to FIG. 2, one example of an implementation of the UE 110 may include a modem 220 having a communication component 222. The communication component 222 and/or the modem 220 of the UE 110 may be configured to communicate with the BS 105 via a cellular network, a Wi-Fi network, or other wireless and wired networks. The UE 110 may include the repetition component 198 having the generation component 224 configured to generate scrambling IDs and/or scrambling sequences. The UE 110 may include the scrambling/de scrambling component 226 configured to scramble a bit sequence using a scrambling sequence (e.g., using an XOR operator). And, the UE 110 may include a redundancy component 228 that duplicates scrambled bits prior to transmission. Alternatively, when acting as a receiver device, the scrambling/descrambling component 226 is configured to descramble a transmission that includes duplicated or repeated copies of information scrambled with the same scrambling sequence by applying a same descrambling sequence to the information.

In some implementations, the UE 110 may include a variety of components, including components such as one or more processors 212 and memory 216 and transceiver 202 in communication via one or more buses 244, which may operate in conjunction with the modem 220 and the communication component 222 to enable one or more of the functions described herein related to communicating with the BS 105. Further, the one or more processors 212, modem 220, memory 216, transceiver 202, RF front end 288 and one or more antennas 265, may be configured to support voice and/or data calls (simultaneously or non-simultaneously) in one or more radio access technologies. The one or more antennas 265 may include one or more antennas, antenna elements and/or antenna arrays.

In an aspect, the one or more processors 212 may include the modem 220 that uses one or more modem processors. The various functions related to the communication component 222 may be included in the modem 220 and/or processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiving device processor, or a transceiver processor associated with transceiver 202. Additionally, the modem 220 may configure the UE 110 along with the processors 212. In other aspects, some of the features of the one or more processors 212 and/or the modem 220 associated with the communication component 222 may be performed by transceiver 202.

Also, memory 216 may be configured to store data used herein and/or local versions of applications 275 or the communication component 222, the generation component 224, the scrambling/descrambling component 226, the redundancy component 228, and/or one or more subcomponents being executed by at least one processor 212. Memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining the communication component 222 the communication component 222, the generation component 224, the scrambling/descrambling component 226, the redundancy component 228, and/or one or more of the subcomponents, and/or data associated therewith, when UE 110 is operating at least one processor 212 to execute the communication component 222 the communication component 222, the generation component 224, the scrambling/descrambling component 226, the redundancy component 228, and/or one or more of the subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a RF receiving device. In an aspect, the receiver 206 may receive signals transmitted by at least one BS 105. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 110 may include RF front end 288, which may operate in communication with one or more antennas 265 and transceiver 202 for receiving and transmitting radio transmissions, for example, wireless communications transmitted by at least one BS 105 or wireless transmissions transmitted by UE 110. RF front end 288 may be coupled with one or more antennas 265 and may include one or more low-noise amplifiers (LNAs) 290, one or more switches 292, one or more power amplifiers (PAs) 298, and one or more filters 296 for transmitting and receiving RF signals.

In an aspect, LNA 290 may amplify a received signal at a desired output level. In an aspect, each LNA 290 may have a specified minimum and maximum gain values. In an aspect, RF front end 288 may use one or more switches 292 to select a particular LNA 290 and the specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and the specified gain value based on a desired gain value for a particular application.

Also, for example, one or more filters 296 may be used by RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, RF front end 288 may use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 110 may communicate with, for example, one or more BS 105 or one or more cells associated with one or more BS 105. In an aspect, for example, the modem 220 may configure transceiver 202 to operate at a specified frequency and power level based on the UE configuration of the UE 110 and the communication protocol used by the modem 220.

In an aspect, the modem 220 may be a multiband-multimode modem, which may process digital data and communicate with transceiver 202 such that the digital data is sent and received using transceiver 202. In an aspect, the modem 220 may be multiband and be configured to support multiple frequency bands for a specific communications protocol. In an aspect, the modem 220 may be multimode and be configured to support multiple operating networks and communications protocols. In an aspect, the modem 220 may control one or more components of UE 110 (e.g., RF front end 288, transceiver 202) to enable transmission and/or reception of signals from the network based on a specified modem configuration. In an aspect, the modem configuration may be based on the mode of the modem and the frequency band in use. In another aspect, the modem configuration may be based on UE configuration information associated with UE 110 as provided by the network.

Referring to FIG. 3, one example of an implementation of the BS 105 may include a modem 320 with a communication component 322 configured to transmit data. The communication component 322 and/or the modem 320 the BS 105 may be configured to communicate with the UE 110 via a cellular network, a Wi-Fi network, or other wireless and wired networks. The repetition component 199 of the BS 105 may include the generation component 324 configured to generate scrambling IDs and/or scrambling sequences. The BS 105 may include the scrambling/descrambling component 326 configured to scramble a bit sequence using a scrambling sequence (e.g., using an XOR operator). The BS 105 may include the redundancy component 328 that duplicates scrambled bits prior to transmission. Alternatively, when acting as a receiver device, the scrambling/descrambling component 326 is configured to descramble a transmission that includes duplicated or repeated copies of information scrambled with the same scrambling sequence by applying a same descrambling sequence to the information.

In some implementations, the BS 105 may include a variety of components, including components such as one or more processors 312 and memory 316 and transceiver 302 in communication via one or more buses 344, which may operate in conjunction with the modem 320 and the communication component 322 to enable one or more of the functions described herein related to communicating with the UE 110. Further, the one or more processors 312, modem 320, memory 316, transceiver 302, RF front end 388 and one or more antennas 365, may be configured to support voice and/or data calls (simultaneously or non-simultaneously) in one or more radio access technologies. The one or more antennas 365 may include one or more antennas, antenna elements and/or antenna arrays.

In an aspect, the one or more processors 312 may include the modem 320 that uses one or more modem processors. The various functions related to the communication component 322, the generation component 324, the scrambling/descrambling component 326, and/or the redundancy component 328 may be included in the modem 320 and/or processors 312 and, in an aspect, may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiving device processor, or a transceiver processor associated with transceiver 302. Additionally, the modem 320 may configure the BS 105 and processors 312. In other aspects, some of the features of the one or more processors 312 and/or the modem 320 associated with the communication component 322 may be performed by transceiver 302.

Also, memory 316 may be configured to store data used herein and/or local versions of applications 375 or the communication component 322, the generation component 324, the scrambling/descrambling component 326, the redundancy component 328 and/or one or more of the subcomponents being executed by at least one processor 312. Memory 316 may include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining the communication component 322, the generation component 324, the scrambling/descrambling component 326, the redundancy component 328 and/or one or more of the subcomponents, and/or data associated therewith, when the BS 105 is operating at least one processor 312 to execute the communication component 322, the generation component 324, the scrambling/descrambling component 326, the redundancy component 328, and/or one or more of the subcomponents.

Transceiver 302 may include at least one receiving device 306 and at least one transmitter 308. The at least one receiving device 306 may include hardware, firmware, and/or software code executable by a processor for receiving data, the code comprising instructions and being stored in a memory (e.g., computer-readable medium). Receiving device 306 may be, for example, a RF receiving device. In an aspect, receiving device 306 may receive signals transmitted by the UE 110. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, the BS 105 may include RF front end 388, which may operate in communication with one or more antennas 365 and transceiver 302 for receiving and transmitting radio transmissions, for example, wireless communications transmitted by other BS 105 or wireless transmissions transmitted by UE 110. RF front end 388 may be coupled with one or more antennas 365 and may include one or more low-noise amplifiers (LNAs) 390, one or more switches 392, one or more power amplifiers (PAs) 398, and one or more filters 396 for transmitting and receiving RF signals.

In an aspect, LNA 390 may amplify a received signal at a desired output level. In an aspect, each LNA 390 may have a specified minimum and maximum gain values. In an aspect, RF front end 388 may use one or more switches 392 to select a particular LNA 390 and the specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and the specified gain value based on a desired gain value for a particular application.

Also, for example, one or more filters 396 may be used by RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, RF front end 388 may use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that BS 105 may communicate with, for example, the UE 110 or one or more cells associated with one or more BS 105. In an aspect, for example, the modem 320 may configure transceiver 302 to operate at a specified frequency and power level based on the base station configuration of the BS 105 and the communication protocol used by the modem 320.

In an aspect, the modem 320 may be a multiband-multimode modem, which may process digital data and communicate with transceiver 302 such that the digital data is sent and received using transceiver 302. In an aspect, the modem 320 may be multiband and be configured to support multiple frequency bands for a specific communications protocol. In an aspect, the modem 320 may be multimode and be configured to support multiple operating networks and communications protocols. In an aspect, the modem 320 may control one or more components of the BS 105 (e.g., RF front end 388, transceiver 302) to enable transmission and/or reception of signals from the network based on a specified modem configuration. In an aspect, the modem configuration may be based on the mode of the modem and the frequency band in use. In another aspect, the modem configuration may be based on base station configuration associated with the BS 105.

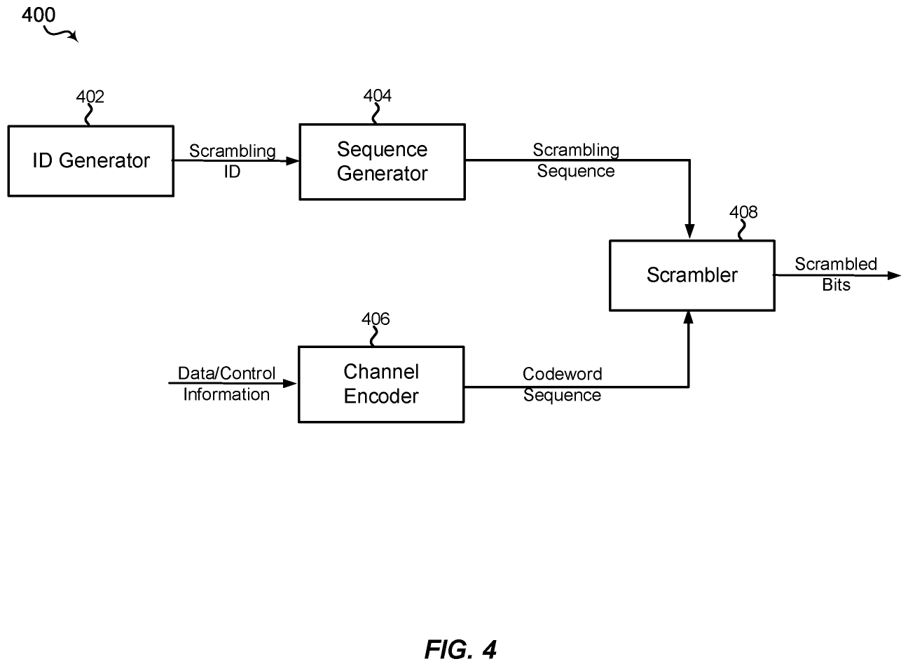

Referring now to FIG. 4, in some implementations, an example of a process 400 for scrambling data and/or control information for a transmission burst may be performed by a transmitter, such as a BS 105 or a UE 110. The process 400 may include an ID generator 402 that generates a scrambling ID (Cᵢₙᵢₜ^{PHY}). In one implementation, the scrambling ID may have a length (L) of more than or equal to 31 bits. The ID generator 402 may generate a random or pseudorandom number as the scrambling ID. The ID generator 402 may generate the scrambling ID based on a weighted combination of a cell ID (N_{ID}^{cell}) associated the communication network 100, a UE ID or UE group ID (N_{ID}^{UE}), and/or an index of the transmission burst (N_{ID}^{Burst}) as shown in the following equation:

Cᵢₙᵢₜ^{PHY}=(w₁×N_{ID}^{cell}+w₂×N_{ID}^{ue}+w₃×N_{ID}^{burst})mod(2^{L}−1),

where the weight factors are greater than or equal to 0, wₖ≥0, k=1, 2, 3. The cell ID, the UE ID or UE group ID, and/or the transmission burst may be signaled by the system information (SI) and/or radio resource configuration (RRC).

In some instances, the process 400 may include a sequence generator 404 that generates a scrambling sequence based on the scrambling ID generated by the ID generator 402. For example, the scrambling sequence may have a form such as c(0), c(1), c(2), . . . , c(M_{bit}−1). The sequence generator 404 may use algorithms (e.g., hash function) or a portion of the scrambling ID to generate the scrambling sequence.

In an implementation, the process 400 may include a channel encoder 406 that encodes data and/or control information into a codeword sequence. For example, the codeword sequence may have a form such as b(0), b(1), b(2), . . . , b(M_{bit}−1). The channel encoder 406 may use polar code, repetition code, simplex code, turbo code, convolution code, low density parity check code, or other suitable code to encode the data and/or control information.

In certain instances, the process 400 may include a scrambler 408 that scrambles the codeword sequence using the scrambling sequence. For example, the scrambler 408 may perform an exclusive-or (XOR) operation using the codeword sequence and the scrambling sequence as input. The output of the XOR operation may be the scrambled bits of the codeword sequence. For example, the scrambled bits of the codeword sequence may have a form such as \tilde{b}(0), \tilde{b}(1), \tilde{b}(2), . . . , \tilde{b}(M_{bit}−1), where \tilde{b}(0i)=(\tilde{b}(i)+\tilde{c}(i)) mod 2. For a transmission burst involving multiple repetitions of a codeword carrying data/control information (e.g., unicast, multicast, or broadcast), the scrambling sequence may be applied repeatedly to each repetition of the codeword. Thus, the transmission scheme of the codeword stays the same within a given transmission burst.

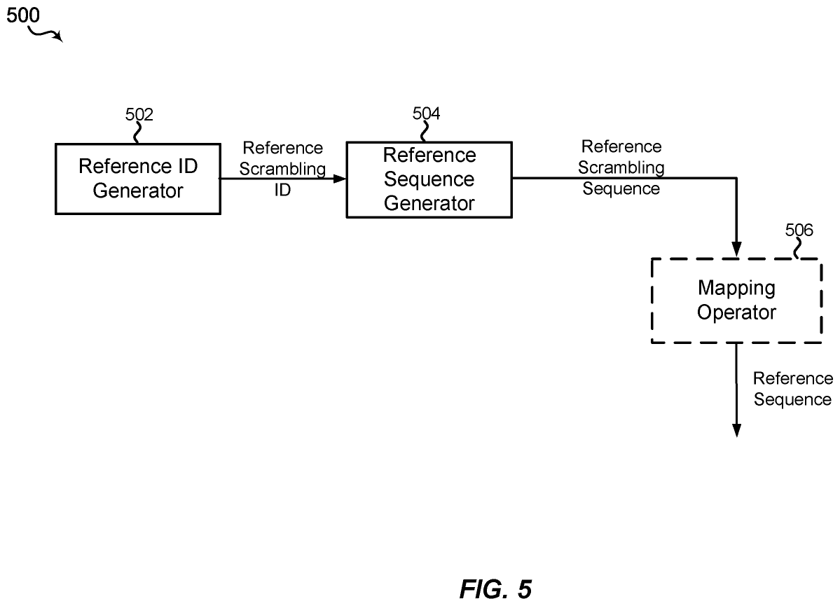

Turning to FIG. 5, an example of a process 500 for generating a reference sequence for a reference signal in a transmission burst may be performed by a transmitter, such as a BS 105 or a UE 110. The process 500 may include a reference ID generator 502 that generates a reference scrambling ID (Cᵢₙᵢₜ^{RS}). In one implementation, the reference scrambling ID may have a length (Q) of more than or equal to 31 bits. The reference ID generator 502 may generate a random or pseudorandom number as the reference scrambling ID. The ID generator reference 502 may generate the reference scrambling ID based on a weighted combination of a cell ID (N_{ID}^{cell}) associated the communication network 100, a UE ID or UE group ID (N_{ID}^{UE}), an index of the transmission burst (N_{ID}^{Burst}), and the relative symbol position (lₙ) of the reference signal with respect to the beginning of the transmission burst (l₀), as shown in the following equation:

Cᵢₙᵢₜ^{RS}=(q₁×N_{ID}^{cell}+q₂×N_{ID}^{ue}+q₃×(q₄×N_{ID}^{burst}+lₙ))mod(2^{Q}−1).

where the weight factors are greater than or equal to 0, Qₖ≥0, k=1, 2, 3, 4. The cell ID, the UE ID or UE group ID, and/or the transmission burst may be signaled by the system information (SI) and/or radio resource configuration (RRC). In an implementation, when the reference sequence is a DMRS sequence, the BS 105 and/or UE 110 may optionally use a reference scrambling ID that is identical to the reference scrambling ID (FIG. 4) used to scramble the data and/or control information.

In some instances, the process 500 may include a reference sequence generator 504 that generates a reference scrambling sequence based on the reference scrambling ID generated by the reference ID generator 502. The reference sequence generator 504 may use algorithms (e.g., hash function) or a portion of the reference scrambling ID to generate the reference scrambling sequence. For example, the reference scrambling sequence may have a form such as c(0), c(1), c(2), . . . .

In an optional aspect, the process 500 may include a mapping operator 506 that maps the reference scrambling sequence to a reference sequence for a transmission burst having multiple repetitions of the reference signals. In one example, the mapping operator 506 may map the reference scrambling sequence (e.g., a binary pseudorandom noise sequence) to the reference sequence (e.g., a 4-bit quaternary sequence) by repeatedly applying the binary sequence to generate the real and imaginary parts of the quaternary sequence using the equation below:

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) ,$$

where c(k) is the output (e.g., reference scrambling sequence) of the reference sequence generator 504. The reference sequence generator 504 outputs a base sequence used by a DL or UL reference signal to a multiplexer or radio resource mapping component. Thus, as described herein, the base sequence applied to a reference signal stays the same within a given transmission burst.

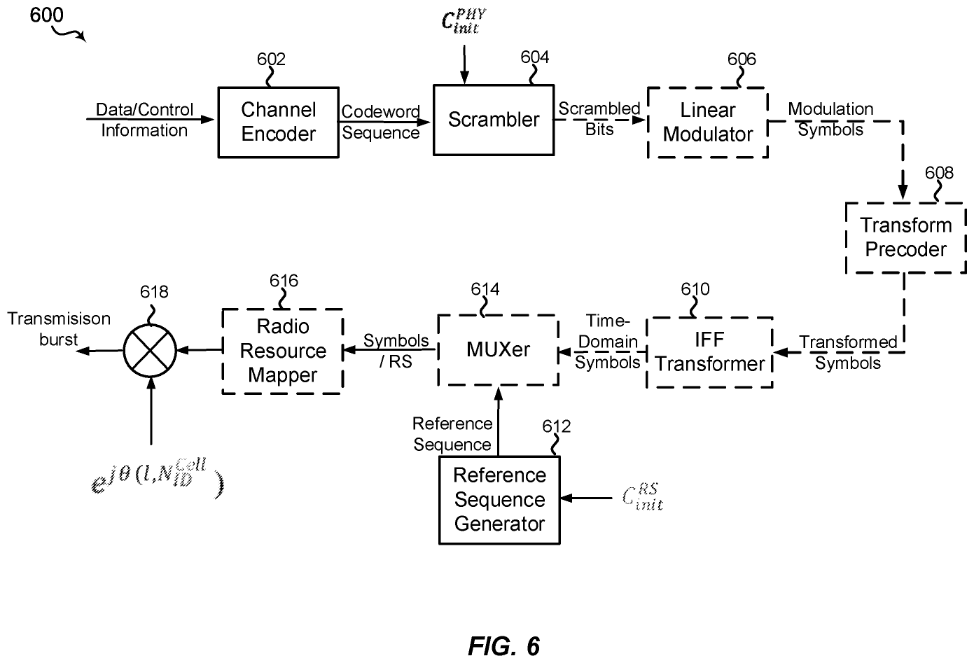

Turning to FIG. 6, in certain aspects, an example of a process 600 of transmitting repeated information in a transmission burst, where each of the repeated information in the transmission burst has a same sequence as generated by process 400 and/or process 500. The scrambler 604 in process 600 is the same as or similar to the scrambler 408 in process 400. Similarly the reference sequence generator 612 in process 600 is the same as or similar to the reference sequence generator 504 in process 500. The process 600 may be performed by a transmitter such as the UE 110 or the BS 105. The process 600 may include a channel encoder 602 that encodes data and/or control information into a codeword sequence. The channel encoder 602 may use polar code, repetition code, simplex code, turbo code, convolution code, low density parity check code, or other suitable code to encode the data and/or control information.

In certain implementations, the process 600 may include a scrambler 604 that scrambles the codeword sequence. As noted above, the scrambler 604 in process 600 is the same as or similar to the scrambler 408 in process 400. For example, the scrambler 604 may obtain a scrambling ID as described above. The scrambling ID may be a random or pseudorandom number, or an ID based on a weighted combination of a cell ID associated the communication network 100, a UE ID or UE group ID, and/or an index of the transmission burst. The scrambler 604 may generate a scrambling sequence based on the scrambling ID. The scrambler 604 may perform an exclusive-or (XOR) operation using the codeword sequence and the scrambling sequence as input. The output of the XOR operation may be the scrambled bits of the codeword sequence. In one example of the scrambling procedure, a codeword sequence of 10101001 being scrambled by a scrambling sequence of 11100111 using an XOR operation may result in scrambled bits of 01001110.

In an aspect of the present disclosure, the same scrambling sequence may be applied to multiple repeated codeword sequences for a burst transmission. By using the same scrambling sequence for the repeated codeword sequences, the transmitter (UE 110 or BS 105) may conserve computational resources as compared to applying different scrambling sequences for the repeated codeword sequences.

In some implementations, the process 600 may optionally include a linear modulator 606. The linear modulator 606 may map the bits of the codeword sequence onto the I (real) and Q (imaginary) components of the, for example, Quadrature Amplitude Modulation (QAM) symbols and then order them in a sequence with specific length according to the number of subcarriers. The linear modulator 606 may output modulation symbols. The modulation symbols may be constructed as orthogonal frequency division multiplexing (OFDM) symbols, frequency division multiple access (FDMA) symbols, time division multiple access (TDMA) symbols, code division multiple access (CDMA) symbols, or other suitable symbols.

In optional implementations, the process 600 may optionally include a transform precoder 608. The transform precoder 608 may spread the modulation symbols across multiple carriers subbands to reduce peak-to-average power ratio. The transform precoder 608 may use a Discrete Fourier Transform, a Zadoff-Chu Matrix Transform, or other techniques to transform the modulation symbols into transformed symbols.

In some implementations, the process 600 may optionally include an Inverse Fast Fourier (IFF) transformer 610. The IFF transformer 610 may transform the transformed symbols from the frequency domain into the time domain to generate time-domain symbols.

In an implementation, the process 600 may include a reference sequence generator 612. As noted above, the reference sequence generator 612 in process 600 is the same as or similar to the reference sequence generator 504 in process 500. The reference sequence generator 612 may obtain a reference scrambling ID (Cᵢₙᵢₜ^{RS}) as described above. The reference scrambling ID may include a random or pseudorandom number, or a number based on a weighted combination of a cell ID (N_{ID}^{cell}) associated the communication network 100, a UE ID or UE group ID, an index of the transmission burst, and the relative symbol position of the reference signal with respect to the beginning of the transmission burst. The reference sequence generator 612 may generate a reference scrambling sequence based on the reference scrambling ID. In certain implementations, the reference sequence generator 612 may map the reference scrambling sequence (e.g., a binary pseudorandom noise sequence) to the reference sequence (e.g., a 4-bit quaternary sequence).

In some implementations, the process 600 may optionally include a multiplexer (MUX) 614 that interleaves the time domain symbols and the reference sequence to generate the symbols/RS bits.

In some implementations, the process 600 may include a radio resource mapper 616 that maps the symbols/RS bits into transmission symbols (e.g., OFDM symbols). The transmission symbols (e.g., OFDM symbols in the time domain) may be mapped into different radio resources for transmission.

In some implementations, the process 600 may apply a tensor operation 618 to perform a phase rotation (i.e., randomization) to the transmission symbols to mitigate the inter-cell interference. The tensor operation 618 may apply a phase rotation to each symbol in the transmission burst for the serving cell, as described in more detail below. The phase rotation (e^{jθ(l,N}^{_{ID}}^{^{Cell}}) may be a function of a relative symbol index (l) within the slot (e.g., 0≤l≤N_{symbol}^{slot}−1) and the cell ID of the serving cell. Alternatively or additionally, the phase rotation may be a function of the transmission burst index. The phase rotation value may be found in a look up table or derived from an equation. After the phase rotation operation, the tensor operation 618 may output transmission symbols with phase rotation for transmission.

In some aspects of the current disclosure, the transmitter may transmit a transmission burst including repeated copies of the transmission symbols.

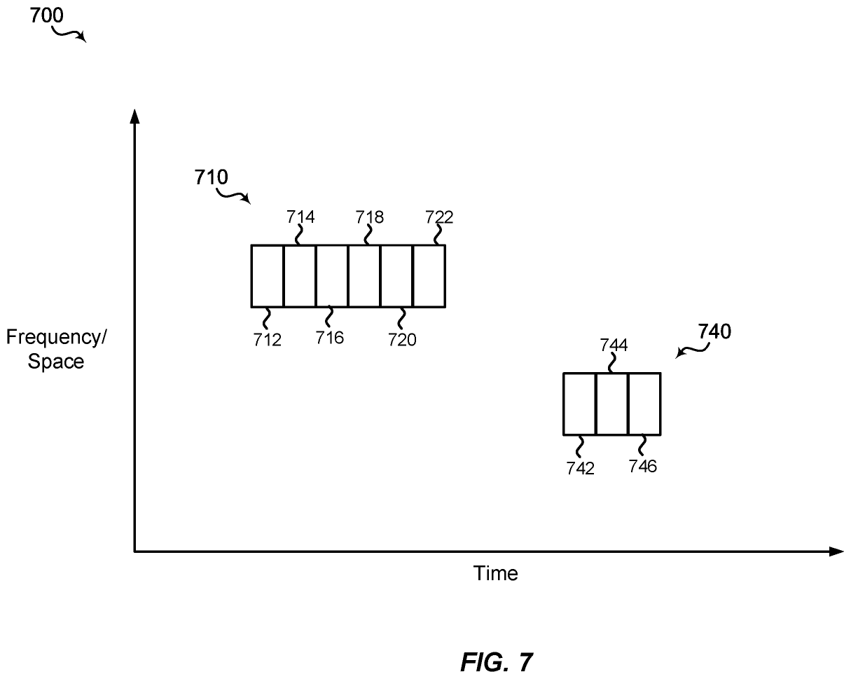

Referring to FIG. 7, an example of prolonged, repeated transmissions 700 that may be generated by the operation of process 600 (without the optional tensor operation 618) includes a first transmission burst 710 having repeated information scrambled by a first scrambling sequence and a second transmission burst 740 having the same repeated information as the first transmission burst 710 but the information is scrambled by a second scrambling sequence different from the first scrambling sequence. Further, in some implementations, the second transmission burst 740 is sent on different resources than the first transmission burst 710 for transmission diversity. Additionally, the second transmission burst Both of the first transmission burst 710 and the second transmission burst 740 are sent by the same transmitter, such as the UE 110 or the BS 105.

More specifically, the first transmission burst 710 may include symbols 712, 714, 716, 718, 720, 722. The symbols 712, 714, 716, 718, 720, 722 may be redundant. The symbols 712, 714, 716, 718, 720, 722 may carry the same information. The symbols 712, 714, 716, 718, 720, 722 may be scrambled by a first scrambling sequence. The symbols 712, 714, 716, 718, 720, 722 may be interleaved with the reference signals scrambled with a first reference scrambling sequence. The first scrambling sequence and the first reference scrambling sequence may be identical or different.

In some implementations, the second transmission burst 740 may include symbols 742, 744, 746. The symbols 742, 744, 746 may be redundant. The symbols 742, 744, 746 may carry the same information. The symbols 742, 744, 746 may be scrambled by a second scrambling sequence. The symbols 742, 744, 746 may be interleaved with the reference signals scrambled with a second reference scrambling sequence. The second scrambling sequence and the second reference scrambling sequence may be identical or different.

In certain aspects, the first scrambling sequence may be different from the second scrambling sequence. The first scrambling sequence may be generated based on a first scrambling ID. The second scrambling sequence may be generated based on a second scrambling ID. The first scrambling ID may be different from the second scrambling ID. The first reference scrambling sequence may be different from the second reference scrambling sequence. The first reference scrambling sequence may be generated based on a first reference scrambling ID. The second reference scrambling sequence may be generated based on a second reference scrambling ID. The first reference scrambling ID may be different from the second reference scrambling ID. The transmitter may transmit the first transmission burst 710 via a first transmission scheme (e.g., frequency hopping, redundant version cycling, pre-coder cycling, etc.). The transmitter may transmit the second transmission burst 740 via a second transmission scheme (e.g., frequency hopping, redundant version cycling, pre-coder cycling, etc.).

While the symbols 712, 714, 716, 718, 720, 722 of the first transmission burst 710 are shown as contiguous in time, the symbols 712, 714, 716, 718, 720, 722 may be non-contiguous in time.

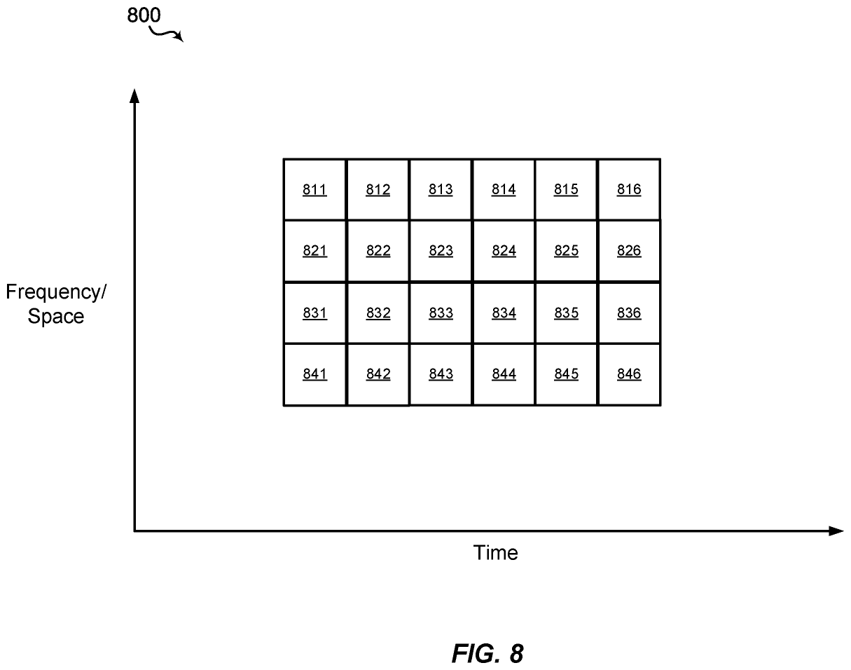

Turning to FIG. 8, an example of transmitted resources 800 resulting from the operation of the optional tensor operation 618 (see FIG. 6) have a same amount of phase rotation applied across all resource elements of a symbol. For instance, in this example, resources 811-816, 821-826, 831-836, 841-846 are transmitted by a transmitter (e.g., the UE 110 or the BS 105) according to aspects of the present disclosure to provide repeated information and to mitigate inter-cell interference.

For example, the information in the resources 811-816 (e.g., symbols, slots, or mini-slots) may be redundant. Further, the information in the resources 811-816 may be scrambled by the same scrambling sequence. The information in resources 821-826, 831-836, and 841-846 may also be redundant, and a respective, same scrambling sequence is applied to each of these sets, although the scrambling sequence is different for each set, e.g., there are four different scrambling sequences.

In certain instances, the resource 811 may include a first phase rotation. The resource 812 may include a second phase rotation. The resource 813 may include a third phase rotation. The resource 814 may include a fourth phase rotation. The resource 815 may include a fifth phase rotation. The resource 816 may include a sixth phase rotation. The first, second, third, fourth, fifth, and sixth phase rotations may be different.

In an implementation, the resource elements transmitted in the same symbol may have the same phase rotation. For example, the resources 811, 821, 831, 841 may have the first phase rotation. The resources 814, 824, 834, 844 may have the fourth phase rotation.

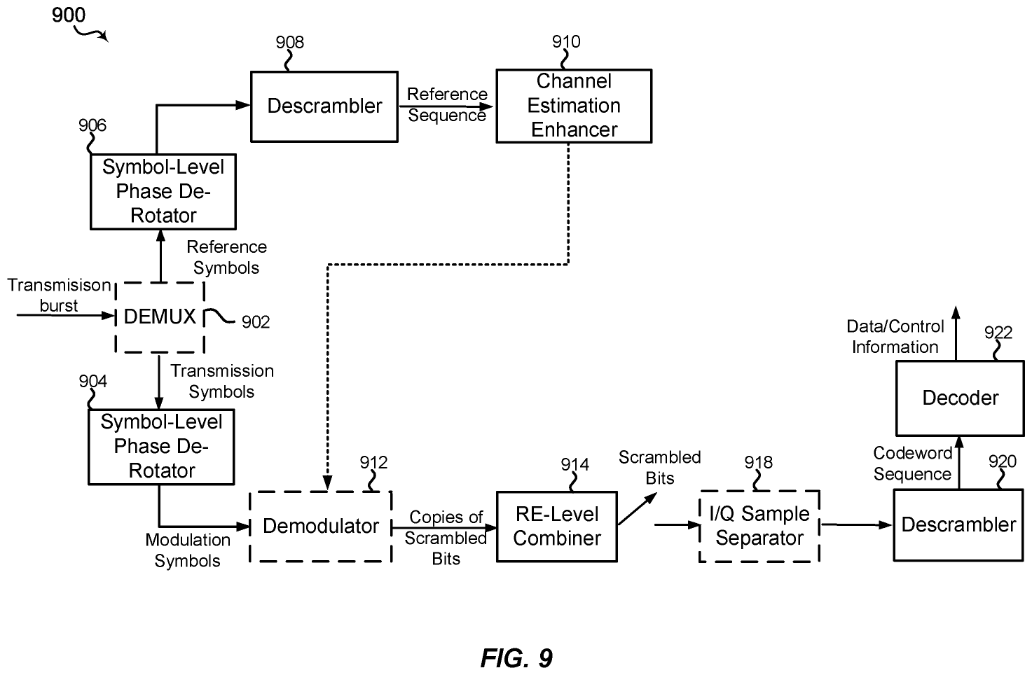

Turning now to FIG. 9, a process 900 for receiving a transmission burst may be performed by a receiver such as the UE 110 or the BS 105. The process 900 may include a demultiplexer (DEMUX) 902. The DEMUX 902 may receive a transmission burst having repeated copies of the transmission symbols. The DEMUX 902 may separate the transmission symbols from any reference signals. The DEMUX 902 may provide the transmission symbols into a first stream and the reference signals into a second stream.

In some optional implementations, the process 900 may include a symbol-level phase de-rotator 904 that removes the phase rotation inserted (at tensor operation 618) into the transmission symbols prior to transmission. Similarly, the process 900 may include a symbol-level phase de-rotator 906 that removes the phase rotation inserted (at tensor operation 618) into the reference signals prior to transmission.

In certain implementations, the process 900 may include a descrambler 908 for descrambling the reference signals (after phase rotation removed by the symbol-level phase de-rotator 906). The descrambler 906 may descramble the reference signals by performing, e.g., an XOR operation using the reference descrambling sequence and the reference signals as input to generate the reference sequence. For example, descrambler 908 may be the same as or similar to scrambling/descrambling component 226 of the UE 110 or scrambling/descrambling component 326 of the BS 105.

In an implementation, the process 900 may include a channel estimation enhancer 910 that improves the quality of the channel used for transmitting/receiving the transmission burst based on the reference sequence.

In certain implementations, the process 900 may optionally include a demodulator 912. The demodulator 912 may demodulate the modulation symbols to generate repeated copies of the scrambled bits. The demodulator 912 may receive feedback information (based on the reference sequence) from the channel estimation enhancer 910 to improve the reception (e.g., signal to noise ratio, signal to noise/interference ratio . . . ).

In an implementation, the process 900 may include an resource element (RE)-level combiner 914. The RE-level combiner 914 may receive the repeated copies of the scrambled bits. The repeated copies of the scrambled bits may be used to construct a complete “copy” of the scrambled bits. For example, a first copy of the scrambled bits may include bit values of bits 0-12 and 23-59 of the scrambled bits (e.g., 100 bits total). The second copy of the scrambled bits may include bit values of bits 7-39 and 50-94. The third copy of the scrambled bits may include bit values of bits 0-44 and 78-99. By combining the first copy and the second copy of the scrambled bits, the receiver may only receive bits 0-94 of the scrambled bits. By combining the second copy and the third copy of the scrambled bits, the receiver may only receive bits 0-44 and 50-99 of the scrambled bits. By combining the first copy and the third copy of the scrambled bits, the receiver may only receive 0-59 and 78-99 of the scrambled bits. However, by combining the first copy, the second copy, and the third copy of the scrambled bits, the receiver (via the RE-level combiner) may be able to construct a complete copy of the scrambled bits (bits 0-99).

In an aspect of the present disclosure, the RE-level combiner 914 may send the complete copy of the scrambled bits or copies of the scrambled bits to an I/Q Sample separator 918.

In certain aspects of the present disclosure, the number of repetitions (i.e., copies of the scrambled bits transmitted by the transmitter) may be determined (e.g., by the transmitter, the receiver, the BS 105, and/or the UE 110) based on the channel estimation, the bit-error rate of the transmissions, the percentage of lost packets/bits, etc.

In alternative aspects of the present disclosure, the RE-level combiner 914 may combine all the copies of the scrambled bits to construct the complete copy (if possible) of the scrambled bits. In another aspect, the RE-level combiner 914 rely on less than all the copies of the scrambled bits transmitted by the transmitter to construct the complete copy of the scrambled bit. In one alternative aspect, the RE-level combiner 914 may suspend combining additional copies of the scrambled bit once a complete copy of the scrambled bit has be constructed.

In some aspects, the process 900 may include the I/Q sample separator 918. The I/Q sample separator may separate the I and Q samples in the scrambled bits.

In some aspects of the present disclosure, the process 900 may include a descrambler 920 for descrambling the I and Q samples of the scrambled bits into a codeword sequence. The descrambler 920 may descramble the scrambled bits by performing, e.g., an XOR operation using the descrambling sequence and the scrambled bits as input to generate the codeword sequence. In one example of the descrambling procedure, the scrambled bits of 01001110 being descrambled by a descrambling sequence of 11100111 using an XOR operation may result in the codeword sequence of 10101001.

In an aspect of the present disclosure, the process 900 may include a decoder 922 that decodes the codeword sequence into data and/or control information.

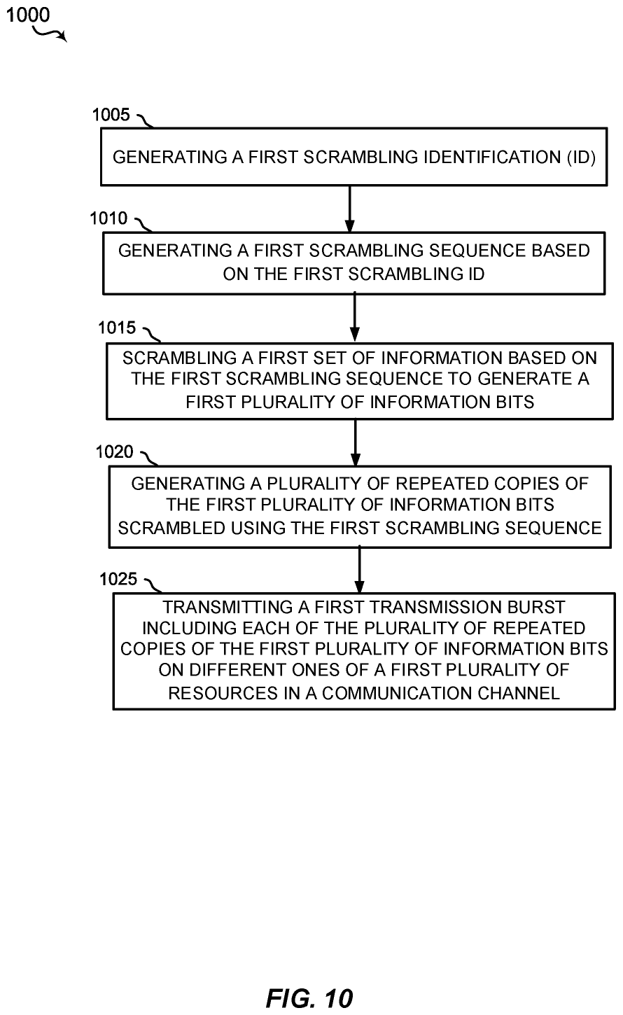

Referring to FIG. 10, an example of a method 1200 for transmitting a transmission burst may be performed by a transmitter, such as the BS 105 including the communication component 322, the repetition component 199, the generation component 324, the scrambling/descrambling component 326, the redundancy component 328, the modem 320, the processor 312, and/or the memory 316 of the BS 105, or the UE 110 including the communication component 222, the repetition component 198, the generation component 224, the scrambling/descrambling component 226, the redundancy component 228, the modem 220, the processor 212, and/or the memory 216 of the UE 110.

At block 1005, the method 1000 may generate a first scrambling identification (ID). For example, the generation component 224, 324, the modem 220, 320, the processor 212, 312, and/or the memory 216, 316 of the UE 110 or the BS 105 may generate the scrambling ID (Cᵢₙᵢₜ^{PHY}).

In certain implementations, the processor 212, 312, the modem 220, 320, the generation component 224, 324, the transceiver 202, 302, the receiver 206, 306, the transmitter 208, 308, the RF front end 288, 388, and/or the subcomponents of the RF front end 288, 388 may be configured to and/or may define means for generating a first scrambling identification (ID).

At block 1010, the method 1000 may generate a first scrambling sequence based on the first scrambling ID. For example, generation component 224, 324, the modem 220, 320, the processor 212, 312, and/or the memory 216, 316 of the UE 110 or the BS 105 may generate a scrambling sequence based on the scrambling ID (Cᵢₙᵢₜ^{PHY}).

In certain implementations, the processor 212, 312, the modem 220, 320, the generation component 224, 324, the transceiver 202, 302, the receiver 206, 306, the transmitter 208, 308, the RF front end 288, 388, and/or the subcomponents of the RF front end 288, 388 may be configured to and/or may define means for generating a first scrambling sequence based on the first scrambling ID.

At block 1015, the method 1000 may scramble a first set of information based on the first scrambling sequence to generate a first plurality of information bits. For example, scrambling/descrambling component 226, 326, the modem 220, 320, the processor 212, 312, and/or the memory 216, 316 of the UE 110 or the BS 105 may perform an exclusive-or (XOR) operation using the codeword sequence and the scrambling sequence as input. The output of the XOR operation may be the scrambled bits of the codeword sequence.

In certain implementations, the processor 212, 312, the modem 220, 320, the scrambling/descrambling component 226, 326, the transceiver 202, 302, the receiver 206, 306, the transmitter 208, 308, the RF front end 288, 388, and/or the subcomponents of the RF front end 288, 388 may be configured to and/or may define means for scrambling a first set of information based on the first scrambling sequence to generate a first plurality of information bits.

At block 1020, the method 1000 may generate a plurality of repeated copies of the first plurality of information bits scrambled using the first scrambling sequence. For example, redundant component 228, 328, the modem 220, 320, the processor 212, 312, and/or the memory 216, 316 of the UE 110 or the BS 105 may generate a plurality of repeated copies of the codeword sequence scrambled using the scrambling sequence.

In certain implementations, the processor 212, 312, the modem 220, 320, the repetition component 198, 199, the redundancy component 228, 328, the transceiver 202, 302, the receiver 206, 306, the transmitter 208, 308, the RF front end 288, 388, and/or the subcomponents of the RF front end 288, 388 may be configured to and/or may define means for generating a plurality of repeated copies of the first plurality of information bits scrambled using the first scrambling sequence.

At block 1025, the method 1000 may transmit a first transmission burst including each of the plurality of repeated copies of the first plurality of information bits on different ones of a first plurality of resources in a communication channel. For example, the communication component 222, 322, the modem 220, 320, and/or the processor 212, 312 of the UE 110 or the BS 105 may transmit a transmission burst including the plurality of repeated copies of the plurality of information bits on different ones of a plurality of resources. The communication component 222, 322 may send the transmission burst to the transceiver 202, 302 or the transmitter 204, 304. The transceiver 202, 302 or the transmitter 204, 304 may convert the transmission burst to electrical signals and send to the RF front end 288, 388. The RF front end 288, 388 may filter and/or amplify the electrical signals. The RF front end 288, 388 may send the electrical signals as electro-magnetic signals via the one or more antennas 265, 365.

In certain implementations, the processor 212, 312, the modem 220, 320, the communication component 222, 322, the transceiver 202, 302, the receiver 206, 306, the transmitter 208, 308, the RF front end 288, 388, and/or the subcomponents of the RF front end 288, 388 may be configured to and/or may define means for transmitting a first transmission burst including each of the plurality of repeated copies of the first plurality of information bits on different ones of a first plurality of resources in a communication channel.

Alternatively or additionally, the method 1000 may further include any of the methods above, further comprising: generating a second scrambling ID, generating a second scrambling sequence based on the second scrambling ID, scrambling the first set of information based on the second scrambling sequence to generate a second plurality of information bits, generating a second transmission burst including a plurality of repeated copies of the second plurality of information bits scrambled using the second scrambling sequence, and transmitting each of the plurality of repeated copies of the second plurality of information bits of the second transmission burst on different ones of a second plurality of resources in the communication channel, wherein the second plurality of resources is different from the first plurality of resources.

Alternatively or additionally, the method 1000 may further include any of the methods above, further comprising, prior to transmitting each of the plurality of repeated copies of the first plurality of information bits of the first transmission burst, mapping the first plurality of information bits into at least one symbol, and applying a phase rotation to the at least one symbol.

Alternatively or additionally, the method 1000 may further include any of the methods above, wherein the different ones of the plurality of resources are contiguous or non-contiguous in a time domain.

Alternatively or additionally, the method 1000 may further include any of the methods above, wherein transmitting each of the plurality of repeated copies of the first plurality of information bits of the first transmission burst further comprises transmitting across multiple slots or multiple mini-slots.

Alternatively or additionally, the method 1000 may further include any of the methods above, wherein transmitting each of the plurality of repeated copies of the first plurality of information bits of the first transmission burst further comprises transmitting using a first fixed transmission scheme.

Alternatively or additionally, the method 1000 may further include any of the methods above, wherein the first fixed transmission scheme include one or more of a first redundancy version, a first pre coding, or a first frequency mapping.

Alternatively or additionally, the method 1000 may further include any of the methods above, wherein generating the first scrambling sequence comprises generating a first pseudorandom noise sequence based on the first scrambling ID.

Alternatively or additionally, the method 1000 may further include any of the methods above, wherein the first scrambling ID is either a cell ID, when the communication channel is a broadcast channel or a multicast channel, or a user equipment ID, when the communication channel is a unicast channel.

Alternatively or additionally, the method 1000 may further include any of the methods above, wherein the first set of information comprises data information, control information, or both.

Alternatively or additionally, the method 1000 may further include any of the methods above, further comprising generating a reference scrambling ID, generating a reference scrambling sequence based on the reference scrambling ID, generating a reference sequence based on the reference scrambling sequence, multiplexing the reference sequence with at least one of the plurality of repeated copies of the first plurality of information bits, and transmitting the reference sequence with at least one of the plurality of repeated copies of the first plurality of information bits.

Alternatively or additionally, the method 1000 may further include any of the methods above, wherein the reference scrambling sequence is a binary sequence, and generating the reference sequence comprises mapping the reference scrambling sequence to a quaternary sequence.

Alternatively or additionally, the method 1000 may further include any of the methods above, wherein the first scrambling ID is a weighted combination of a cell ID or a random number, a user equipment (UE) ID or a UE group ID, and a transmission burst index.

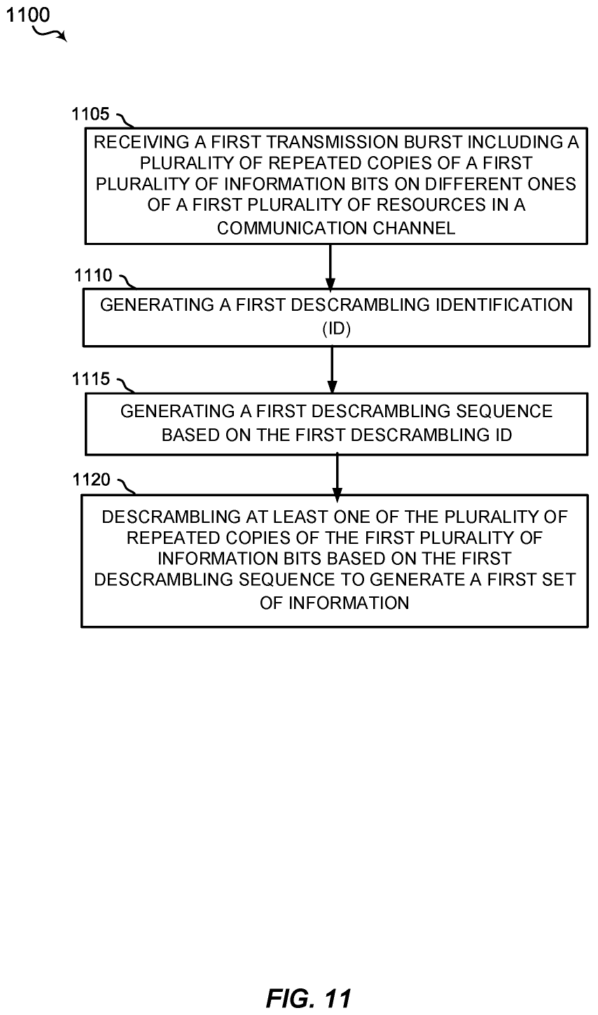

Referring to FIG. 11, an example of a method 1100 for receiving a transmission burst may be performed by a receiver, such as the BS 105 including the communication component 322, repetition component 199, the generation component 324, the scrambling/descrambling component 326, the redundancy component 328, the modem 320, the processor 312, and/or the memory 316 of the BS 105, or the UE 110 including the communication component 222, repetition component 198, the generation component 224, the scrambling/descrambling component 226, the redundancy component 228, the modem 220, the processor 212, and/or the memory 216 of the UE 110.

At block 1105, the method 1100 may receive a first transmission burst including a plurality of repeated copies of a first plurality of information bits on different ones of a first plurality of resources in a communication channel. For example, the communication component 222, 322, the modem 220, 320, and/or the processor 212, 312 of the UE 110 or the BS 105 may receive the transmission burst. The one or more antennas 265, 365 may receive electro-magnetic signals from one or more antennas 265, 365 of the UE 110. The RF front end 288, 388 may filter, amplify, and/or extract electrical signals carried by the electro-magnetic signals. The transceiver 202, 302 or the receiver 206, 306 may digitize and convert the electrical signal into the data, such as the transmission burst, and send to the communication component 222, 322.

In certain implementations, the processor 212, 312, the modem 220, 320, the communication component 222, 322, the repetition component 198, 199, the transceiver 202, 302, the receiver 206, 306, the transmitter 208, 308, the RF front end 288, 388, and/or the subcomponents of the RF front end 288, 388 may be configured to and/or may define means for receiving a first transmission burst including a plurality of repeated copies of a first plurality of information bits on different ones of a first plurality of resources in a communication channel.

At block 1110, the method 1100 may generate a first descrambling identification (ID). For example, the generation component 224, 324, the modem 220, 320, the processor 212, 312, and/or the memory 216, 316 of the UE 110 or the BS 105 may generate the descrambling ID.

In certain implementations, the processor 212, 312, the modem 220, 320, the generation component 224, 324, the transceiver 202, 302, the receiver 206, 306, the transmitter 208, 308, the RF front end 288, 388, and/or the subcomponents of the RF front end 288, 388 may be configured to and/or may define means for generating a first descrambling identification (ID).

At block 1115, the method 1100 may generate a first de scrambling sequence based on the first scrambling ID. For example, generation component 224, 324, the modem 220, 320, the processor 212, 312, and/or the memory 216, 316 of the UE 110 or the BS 105 may generate a scrambling sequence based on the descrambling ID.

In certain implementations, the processor 212, 312, the modem 220, 320, the generation component 224, 324, the transceiver 202, 302, the receiver 206, 306, the transmitter 208, 308, the RF front end 288, 388, and/or the subcomponents of the RF front end 288, 388 may be configured to and/or may define means for generating a first descrambling sequence based on the first descrambling ID.

At block 1220, the method 1100 may descramble at least one of the plurality of repeated copies of the first plurality of information bits based on the first descrambling sequence to generate a first set of information. For example, scrambling/descrambling component 226, 326, the modem 220, 320, the processor 212, 312, and/or the memory 216, 316 of the UE 110 or the BS 105 may perform an exclusive-or (XOR) operation using the scrambled bits and the descrambling sequence as input. The output of the XOR operation may be the codeword sequence.

In certain implementations, the processor 212, 312, the modem 220, 320, the scrambling/descrambling component 226, 326, the transceiver 202, 302, the receiver 206, 306, the transmitter 208, 308, the RF front end 288, 388, and/or the subcomponents of the RF front end 288, 388 may be configured to and/or may define means for descrambling at least one of the plurality of repeated copies of the first plurality of information bits based on the first descrambling sequence to generate a first set of information.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (U IRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 NEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

1. A method of wireless communication by a device, comprising:
generating a first scrambling identification (ID);
generating a first scrambling sequence based on the first scrambling ID;
scrambling a first set of information based on the first scrambling sequence to generate a first plurality of information bits;
generating a plurality of repeated copies of the first plurality of information bits scrambled based on the first scrambling sequence; and
transmitting a first transmission burst including each of the plurality of repeated copies of the first plurality of information bits on different ones of a first plurality of resources in a communication channel.

2. The method of claim 1, further comprising:
generating a second scrambling ID;
generating a second scrambling sequence based on the second scrambling ID;
scrambling the first set of information based on the second scrambling sequence to generate a second plurality of information bits;
generating a second transmission burst including a plurality of repeated copies of the second plurality of information bits scrambled based on the second scrambling sequence; and
transmitting each of the plurality of repeated copies of the second plurality of information bits of the second transmission burst on different ones of a second plurality of resources in the communication channel, wherein the second plurality of resources is different from the first plurality of resources.

3. The method of claim 1, further comprising, prior to transmitting each of the plurality of repeated copies of the first plurality of information bits of the first transmission burst:
mapping the first plurality of information bits into at least one symbol; and
applying a phase rotation to the at least one symbol.

4. The method of claim 1, wherein the different ones of the plurality of resources are contiguous or non-contiguous in a time domain.

5. The method of claim 1, wherein transmitting each of the plurality of repeated copies of the first plurality of information bits of the first transmission burst further comprises transmitting across multiple slots or multiple mini-slots.

6. The method of claim 1, wherein transmitting each of the plurality of repeated copies of the first plurality of information bits of the first transmission burst further comprises transmitting using a first fixed transmission scheme.

7. The method of claim 4, wherein the first fixed transmission scheme include one or more of a first redundancy version, a first precoding, or a first frequency mapping.

8. The method of claim 1, wherein generating the first scrambling sequence comprises generating a first pseudorandom noise sequence based on the first scrambling ID.

9. The method of claim 1, wherein the first scrambling ID is either a cell ID, when the communication channel is a broadcast channel or a multicast channel, or a user equipment ID, when the communication channel is a unicast channel.

10. The method of claim 1, wherein the first set of information comprises data information, control information, or both.

11. The method of claim 1, further comprising
generating a reference scrambling ID;
generating a reference scrambling sequence based on the reference scrambling ID;
generating a reference sequence based on the reference scrambling sequence;
multiplexing the reference sequence with at least one of the plurality of repeated copies of the first plurality of information bits; and
transmitting the reference sequence with at least one of the plurality of repeated copies of the first plurality of information bits.

12. The method of claim 11, wherein:
the reference scrambling sequence is a binary sequence; and
generating the reference sequence comprises mapping the reference scrambling sequence to a quaternary sequence.

13. The method of claim 1, wherein the first scrambling ID is a weighted combination of a cell ID or a random number, a user equipment (UE) ID or a UE group ID, and a transmission burst index.

14-16. (canceled)

17. An apparatus for wireless communication by a device, comprising:
at least one processor; and
memory coupled to the at least one processor, the memory storing instructions executable by the at least one processor to configure the device to:
generate a first scrambling identification (ID);
generate a first scrambling sequence based on the first scrambling ID;
scramble a first set of information based on the first scrambling sequence to generate a first plurality of information bits;
generate a plurality of repeated copies of the first plurality of information bits scrambled based on the first scrambling sequence; and
transmit a first transmission burst including each of the plurality of repeated copies of the first plurality of information bits on different ones of a first plurality of resources in a communication channel.

18. The apparatus of claim 17, wherein the instructions are further executable by the at least one processor to configure the device to:
generate a second scrambling ID;
generate a second scrambling sequence based on the second scrambling ID;
scramble the first set of information based on the second scrambling sequence to generate a second plurality of information bits;
generate a second transmission burst including a plurality of repeated copies of the second plurality of information bits scrambled based on the second scrambling sequence; and
transmit each of the plurality of repeated copies of the second plurality of information bits of the second transmission burst on different ones of a second plurality of resources in the communication channel, wherein the second plurality of resources is different from the first plurality of resources.

19. The apparatus of claim 17, wherein the instructions are further executable by the at least one processor to configure the device to:
prior to transmitting each of the plurality of repeated copies of the first plurality of information bits of the first transmission burst:
map the first plurality of information bits into at least one symbol; and
apply a phase rotation to the at least one symbol.

20. The apparatus of claim 17, wherein the different ones of the plurality of resources are contiguous or non-contiguous in a time domain.

21. The apparatus of claim 17, wherein transmitting each of the plurality of repeated copies of the first plurality of information bits of the first transmission burst further comprises transmitting across multiple slots or multiple mini-slots.

22. The apparatus of claim 17, wherein transmitting each of the plurality of repeated copies of the first plurality of information bits of the first transmission burst further comprises transmitting using a first fixed transmission scheme.

23. The apparatus of claim 20, wherein the first fixed transmission scheme include one or more of a first redundancy version, a first precoding, or a first frequency mapping.

24. The apparatus of claim 17, wherein generating the first scrambling sequence comprises generating a first pseudorandom noise sequence based on the first scrambling ID.

25. The apparatus of claim 17, wherein the first scrambling ID is either a cell ID, when the communication channel is a broadcast channel or a multicast channel, or a user equipment ID, when the communication channel is a unicast channel.

26. The apparatus of claim 17, wherein the first set of information comprises data information, control information, or both.

27. The apparatus of claim 17, wherein the instructions are further executable by the at least one processor to configure the device to:
generate a reference scrambling ID;
generate a reference scrambling sequence based on the reference scrambling ID;
generate a reference sequence based on the reference scrambling sequence;
multiplex the reference sequence with at least one of the plurality of repeated copies of the first plurality of information bits; and
transmit the reference sequence with at least one of the plurality of repeated copies of the first plurality of information bits.

28. The apparatus of claim 27, wherein:
the reference scrambling sequence is a binary sequence; and
generating the reference sequence comprises mapping the reference scrambling sequence to a quaternary sequence.

29. The apparatus of claim 17, wherein the first scrambling ID is a weighted combination of a cell ID or a random number, a user equipment (UE) ID or a UE group ID, and a transmission burst index.

30. An apparatus for wireless communication, comprising:
means for generating a first scrambling identification (ID);
means for generating a first scrambling sequence based on the first scrambling ID;
means for scrambling a first set of information based on the first scrambling sequence to generate a first plurality of information bits;
means for generating a plurality of repeated copies of the first plurality of information bits scrambled based on the first scrambling sequence; and
means for transmitting a first transmission burst including each of the plurality of repeated copies of the first plurality of information bits on different ones of a first plurality of resources in a communication channel.

31. A computer-readable medium for wireless communication by a device, the computer-readable medium comprises instructions executable by at least one processor to cause the device to:
generate a first scrambling identification (ID);
generate a first scrambling sequence based on the first scrambling ID;
scramble a first set of information based on the first scrambling sequence to generate a first plurality of information bits;
generate a plurality of repeated copies of the first plurality of information bits scrambled based on the first scrambling sequence; and
transmit a first transmission burst including each of the plurality of repeated copies of the first plurality of information bits on different ones of a first plurality of resources in a communication channel.
